(19) United States
(12) Patent Application Publication
(10) Pub. No.: US 2019/0096610 A1
(43) Pub. Date: Mar. 28, 2019

(54) ELECTRONIC DEVICE

(71) Applicant: KYOCERA CORPORATION, Kyoto (JP)

(72) Inventor: Yasuhito KANEMAKI, Yokohama-shi, Kanagawa (JP)

(73) Assignee: KYOCERA CORPORATION, Kyoto (JP)

(21) Appl. No.: 16/086,288

(22) PCT Filed: Mar. 8, 2017
(86) PCT No.: PCT/JP2017/009280

§ 371 Date: Sep. 18, 2018

(30) Foreign Application Priority Data
Mar. 24, 2016 (JP) 2016-060079

(51) Int. Cl. H01H 23/06; G06F 1/16

(52) U.S. Cl. CPC H01H 23/06; G06F 1/1626; G06F 1/1656

(57) ABSTRACT

An electronic device includes a housing having an opening, a key member including one or more pushers projecting inwardly of the housing, having one or more through-holes or one or more cutaway parts, and disposed to allow the one or more pushers to pass through the opening, one or more switches each disposed to face a corresponding one of the one or more pushers inside the housing, a first waterproof member disposed between each of the one or more pushers and each of the one or more switches, and one or more shaft members fixed to the housing. Each of the one or more shaft members enters the one or more through-holes or the one or more cutaway parts so as to limit part of a displacement of the key member relative to the housing.

### TECHNICAL FIELD

The present disclosure relates to an electronic device.

### BACKGROUND ART

Electronic devices having a waterproof structure are known.

### SUMMARY OF INVENTION

An electronic device based on the present disclosure includes a housing having an opening, a key member including one or more pushers projecting inwardly of the housing, having one or more through-holes or one or more cutaway parts, and disposed to allow the one or more pushers to pass through the opening, one or more switches each disposed to face a corresponding one of the one or more pushers inside the housing, a first waterproof member disposed between each of the one or more pushers and each of the one or more switches, and one or more shaft members fixed to the housing. Each of the one or more shaft members enters the one or more through-holes or the one or more cutaway parts so as to limit part of a displacement of the key member relative to the housing.

### BRIEF DESCRIPTION OF DRAWINGS

FIG. 1 is a perspective view of an electronic device in a first embodiment based on the present disclosure.

FIG. 2 is an exploded view of the electronic device in the first embodiment based on the present disclosure.

FIG. 3 shows a key member and therearound in FIG. 2.

FIG. 4 is a first plan view of the electronic device in the first embodiment based on the present disclosure.

FIG. 5 is an enlarged plan view of a Z1 portion in FIG. 4.

FIG. 6 is a second plan view of the electronic device in the first embodiment based on the present disclosure.

FIG. 7 is a cross-sectional view taken along the line VII-VII in FIG. 6.

FIG. 8 is a cross-sectional view taken along the line VIII-VIII in FIG. 6.

FIG. 9 illustrates only a key member and a shaft member taken out of the electronic device in the first embodiment based on the present disclosure.

FIG. 10 is a plan view of an electronic device in a second embodiment based on the present disclosure.

FIG. 11 is a cross-sectional view taken along the line XI-XI in FIG. 10.

FIG. 12 is a partial cross-sectional view of an electronic device in a third embodiment based on the present disclosure.

FIG. 13 illustrates a key member of an electronic device in a fourth embodiment based on the present disclosure.

FIG. 14 is a partial plan view of a combination of the key member and the shaft member of the electronic device in the first embodiment based on the present disclosure,

FIG. 15 is a partial plan view of a first example of a combination of a key member and a shaft member of an electronic device in a fifth embodiment based on the present disclosure.

FIG. 16 is a partial plan view of a second example of the combination of the key member and the shaft member of the electronic device in the fifth embodiment based on the present disclosure.

FIG. 17 is a partial plan view of a third example of the combination of the key member and the shaft member of the electronic device in the fifth embodiment based on the present disclosure.

FIG. 18 is a partial plan view of a fourth example of the combination of the key member and the shaft member of the electronic device in the fifth embodiment based on the present disclosure.

FIG. 19 illustrates a combination of a key member and a shaft member of an electronic device in a sixth embodiment based on the present disclosure.

FIG. 20 is a cross-sectional view showing an example of a relationship between a housing and a cover glass that are applicable to the electronic devices in the first to sixth embodiments based on the present disclosure.

### DESCRIPTION OF EMBODIMENTS

A dimensional ratio shown in the drawings does not necessarily faithfully represent an actual dimensional ratio, and a dimensional ratio may be exaggerated for the sake of convenience of description. A concept above or upper or below or lower mentioned in the description below does not mean absolute above or upper or below or lower but may mean relative above or upper or below or lower in terms of a shown position.

### First Embodiment

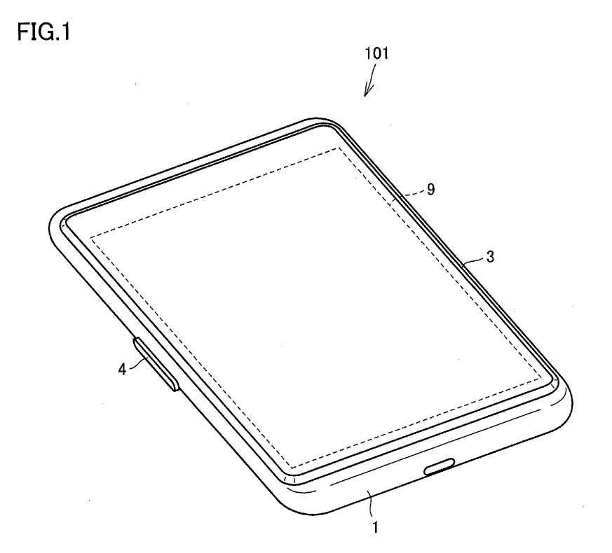

An electronic device in a first embodiment based on the present disclosure will be described with reference to FIGS. 1 to 9. FIG. 1 shows appearance of an electronic device 101 in the first embodiment. Electronic device 101 has a plate shape and has a substantially rectangular outside shape when viewed from above. A cover glass 3 may be disposed on a main surface of electronic device 101. Cover glass 3 may be a plate-shaped glass component. A display 9 may be disposed below cover glass 3. Electronic device 101 includes a housing 1. Housing 1 and cover glass 3 are combined together to constitute most of an outer shell of electronic device 101. A key member 4 is disposed on one side of housing 1. Key member 4 is to be pressed by the user. The user can operate electronic device 101 by pressing key member 4.

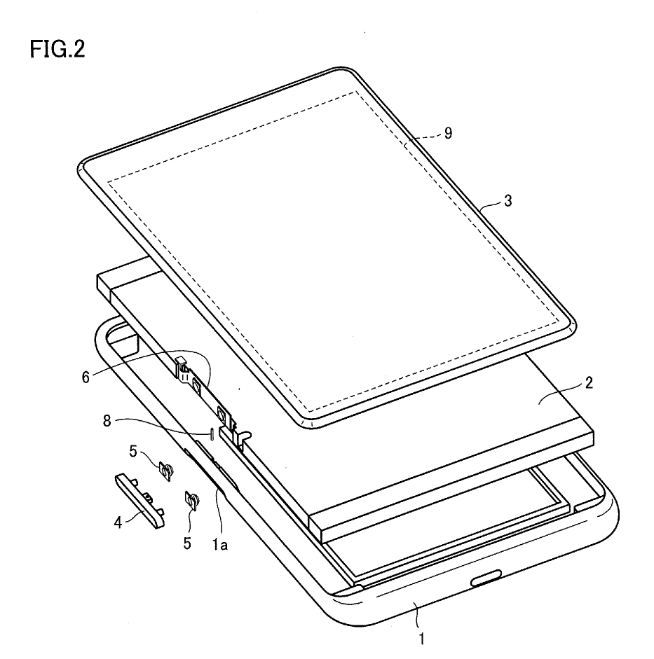

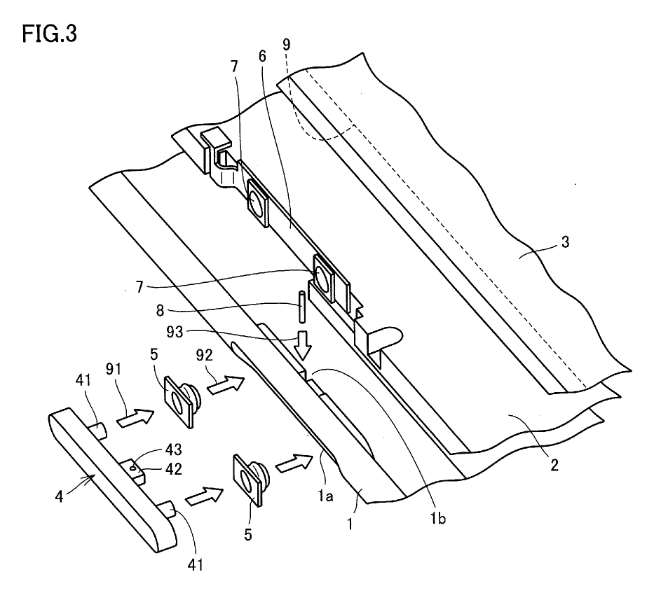

FIG. 2 is an exploded view of electronic device 101. Housing 1 has a bottom surface and side surfaces, and its upper portion side is open. An inner chassis 2 is disposed inside housing 1, and cover glass 3 and a display 9 are layered thereon. Display 9 is disposed below cover glass 3 and is located between cover glass 3 and inner chassis 2. Display 9 may be, for example, a liquid crystal display panel. A flexible substrate 6 is disposed on one side surface of inner chassis 2. Key member 4 and a first waterproof member 5 are disposed on a side surface of housing 1. FIG. 3 shows enlarged key member 4 and therearound in FIG. 2.

Electronic device 101 includes housing 1 having an opening 1a, key member 4 including one or more pushers 41 projecting inwardly of housing 1, having one or more through-holes or one or more cutaway parts, and disposed to allow the one or more pushers 41 to pass through opening 1a, one or more switches 7 each disposed to face a corresponding one of the one or more pushers 41 inside housing 1, first waterproof member 5 disposed between each of the one or more pushers 41 and each of the one or more switches 7, and one or more shaft members 8 fixed to housing 1.

Key member 4 may be made of, for example, resin. In the first embodiment, key member 4 has a through-hole 43 as an example of the “one or more through-holes or one or more cutaway parts.” In the first embodiment, key member 4 includes a protrusion 42, and through-hole 43 is provided in protrusion 42. In the first embodiment, key member 4 has two pushers 41 as an example of “one or more pushers 4.” In the first embodiment, two switches 7 are disposed inside housing 1 as an example of “one or more switches 7.” Two switches 7 are disposed on the surface of flexible substrate 6.

In the first embodiment, electronic device 101 includes one shaft member 8 as an example of “one or more shaft members 8.” Each of the one or more shaft members 8 enters each of the one or more through-holes or the one or more cutaway parts so as to limit part of a displacement of key member 4 relative to housing 1. Shaft member 8 may be formed of, for example, metal. Shaft member 8 may be a pin.

First waterproof member 5 may be, for example, a member referred to as a gasket rubber.

Opening 1a has a size next greater than the size of key member 4. Housing 1 has a cutaway part 1b therein. Though not shown in FIG. 3, a hole for receiving shaft member 8 is provided in the bottom surface of cutaway part 1b. Shaft member 8 is inserted into the hole of cutaway part 1b of housing 1 as indicated by an arrow 93 while passing through through-hole 43 of key member 4, allowing shaft member 8 to be fixed to housing 1.

As shown in FIG. 3, pusher 41 of key member 4 is inserted into first waterproof member 5 as indicated by an arrow 91. First waterproof member 5 is attached to housing 1 through opening 1a as indicated by an arrow 92. Both of key member 4 and first waterproof member 5 are attached from outside of housing 1 through opening 1a.

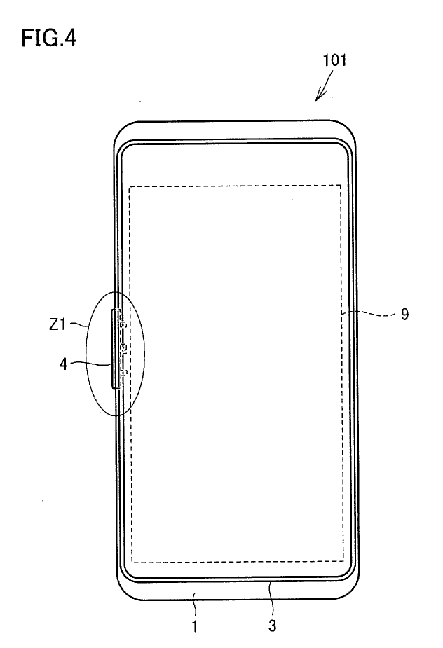

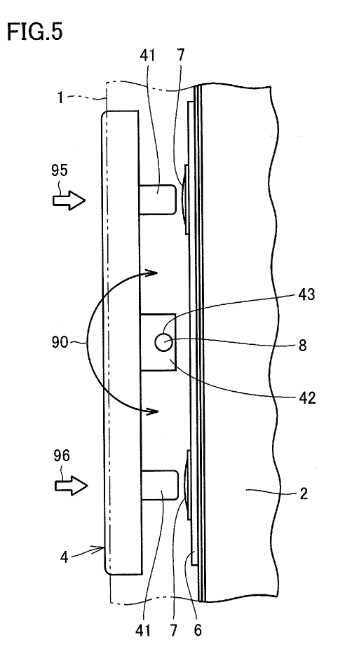

FIG. 4 shows electronic device 101 seen in plan view. Key member 4 is disposed on the left side in FIG. 4. Although the aspect ratio of the outside shape of housing 1 looks different from that of FIG. 1, the outside shape of housing 1 of electronic device 101 may have any aspect ratio. FIG. 5 shows an enlarged Z1 portion in FIG. 4. FIG. 5 does not show some components around key member 4. For example, first waterproof member 5 is not shown. Flexible substrate 6 is disposed on the end surface of inner chassis 2. Each pusher 41 faces switch 7. Key member 4 is supported so as to pivot around shaft member 8 as indicated by an arrow 90. In actuality, the range of the pivot of key member 4 is limited to a range with a certain angle. In the state shown in FIG. 5, both of two pushers 41 do not press switch 7.

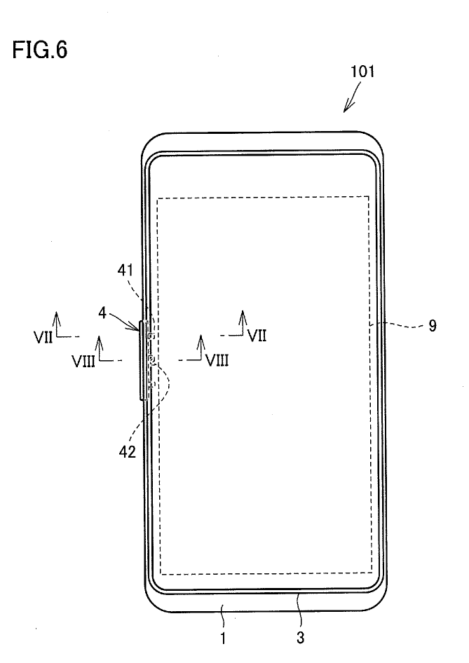

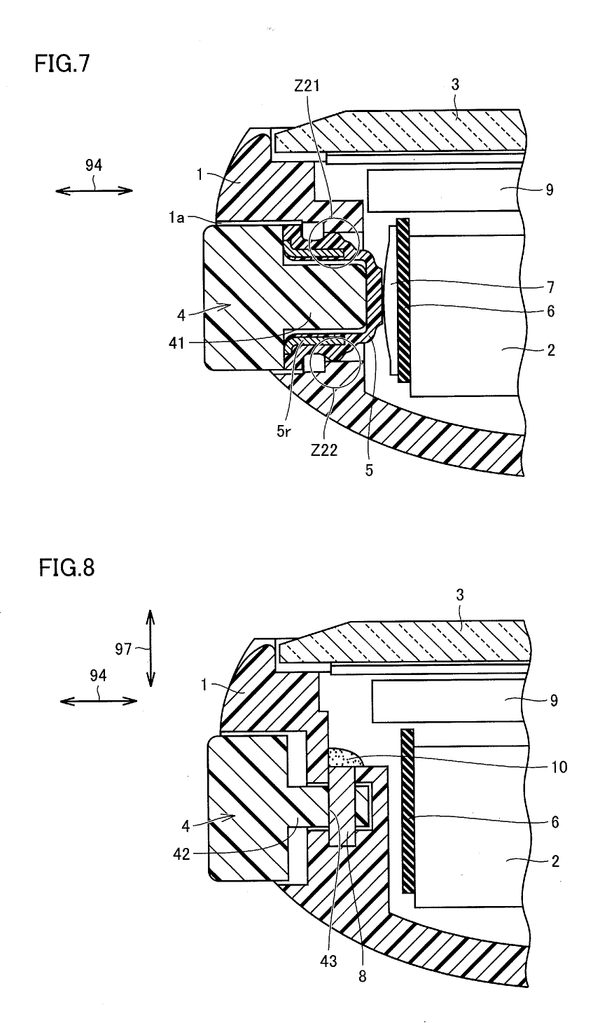

FIG. 6 again shows electronic device 101 seen in plan view. FIG. 7 is a cross-sectional view taken along the line VII-VII in FIG. 6. FIG. 8 is a cross-sectional view taken along the line VIII-VIII in FIG. 6.

As shown in FIG. 7, first waterproof member 5 may include a bag-shaped portion. In the example shown in FIG. 7, the bag-shaped portion of first waterproof member 5 covers pusher 41. First waterproof member 5 may have a projecting portion on the outer peripheral surface of the bag-shaped portion. This projecting portion annularly surrounds the outer peripheral surface of the portion of first waterproof member 5 which projects in a bag shape. As indicated by a Z21 portion and a Z22 portion in FIG. 7, abutment of the projecting portion on the outer peripheral surface of first waterproof member 5 with housing 1 may interrupt water passing therethrough.

As shown in FIG. 7, switch 7 may be a dome switch. Herein, the dome switch may be, for example, a metal dome switch. Key member 4 is pressed to advance pusher 41, so that switch 7 is pressed. First waterproof member 5 may have elasticity. If first waterproof member 5 has elasticity, the bag-shaped portion of first waterproof member 5 can stretch through elastic deformation when pusher 41 advances. As shown in FIG. 7, first waterproof member 5 may include, inside a portion formed of elastic material, a reinforced member 5r stiffer than the elastic material. Reinforced member 5r may be made of metal. Part of reinforced member 5r may not be covered with the elastic material but may be exposed.

Shaft member 8 may be fixed to housing 1 while passing through key member 4. In the example shown in FIG. 8, shaft member 8 is fixed by housing 1 while passing through protrusion 42 of key member 4. The lower end of shaft member 8 is in the hole provided in housing 1. The upper end of shaft member 8 is covered with a sealing member 10; otherwise it would be exposed from housing 1. Sealing member 10 may be an adhesive. Shaft member 8 may be a simple round bar. Although the example in which shaft member 8 is a component separate from key member 4 is described and shown here, a shaft member and a key member may be integrated with each other. For example, the shaft member and the key member may be integrally formed of the same material.

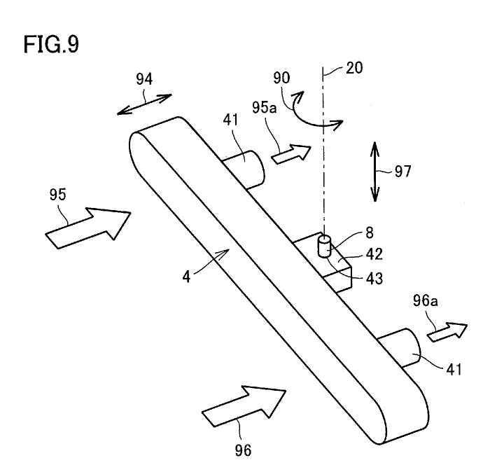

FIG. 9 shows only key member 4 and shaft member 8 taken out of the electronic device. Arrows 95 and 96 indicate a user's pressing force for operating electronic device 101 in FIGS. 5 and 9. The user is expected to press one location of key member 4 according to any one of arrows 95 and 96 without pressing two locations of key member 4 simultaneously according to both of arrows 95 and 96. Pressing key member 4 according to any one of arrows 95 and 96 allows key member 4 to pivot about an axis of rotation 20 by a certain angle, so that pusher 41 on the corresponding side presses switch 7 (not shown in FIG. 9). When key member 4 is pressed according to arrow 95 shown in FIG. 9, pusher 41 at the upper left in the figure advances as indicated by an arrow 95a and presses switch 7 disposed to face this pusher 41. When key member 4 is pressed according to arrow 96 shown in FIG. 9, pusher 41 at the lower right in the figure advances as indicated by an arrow 96a and presses switch 7 disposed to face this pusher 41.

In the first embodiment, key member 4 can be attached from outside of housing 1, and key member 4 is pivotally fixed with the aid of shaft member 8 while achieving waterproof performance by first waterproof member 5. This achieves an electronic device including operation keys appropriately disposed in a limited space of the housing while achieving some degree of waterproof performance.

As shown in FIG. 8 and the like in the first embodiment, a longitudinal direction 97 of each of the one or more shaft members 8 may be perpendicular to forward and backward directions 94 of one or more pushers 41. This configuration allows the key member to pivot by effectively using a limited space, allowing the pusher to be effectively displaced.

As shown in FIGS. 5 and 9 in the first embodiment, two pushers 41 may be provided, one through-hole or one cutaway part may be provided, and the one through-hole or the one cutaway part may be located between two pushers 41. The axis of pivot of the key member is located between the two pushers in this configuration, allowing the key member to make a movement similar to a seesaw. Thus, any one of the two pushers is selected to be pressed. With the aid of this, a button for appropriately performing an operation in one direction and an operation in the opposite direction can be achieved. For example, when an electronic device includes a speaker, such a button can be used as a button for performing a selective operation of turning up/down the speaker. Alternatively, as to the selection from among choices, such a button can be used as a button for forward/backward switching of choices.

As shown in, for example, FIGS. 3 and 7 in the first embodiment, first waterproof member 5 has a bag shape, and each of one or more pushers 41 may be covered with first waterproof member 5. This configuration allows first waterproof member 5 to be attached to pusher 41 with sufficient stability.

As shown in FIG. 8 in the first embodiment, a second waterproof member may be disposed to be in contact with shaft member 8 and housing 1. In FIG. 8, sealing member 10 corresponds to the second waterproof member. Sealing member 10 is in contact with shaft member 8 and housing 1. Disposing the second waterproof member to be in contact with shaft member 8 and housing 1 can reduce a probability that water may enter the region inside of housing 1 through a gap around shaft member 8 when the electronic device is exposed to water.

### Second Embodiment

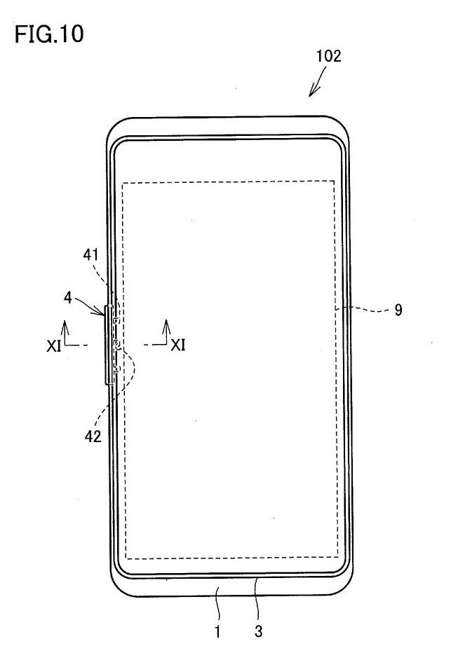

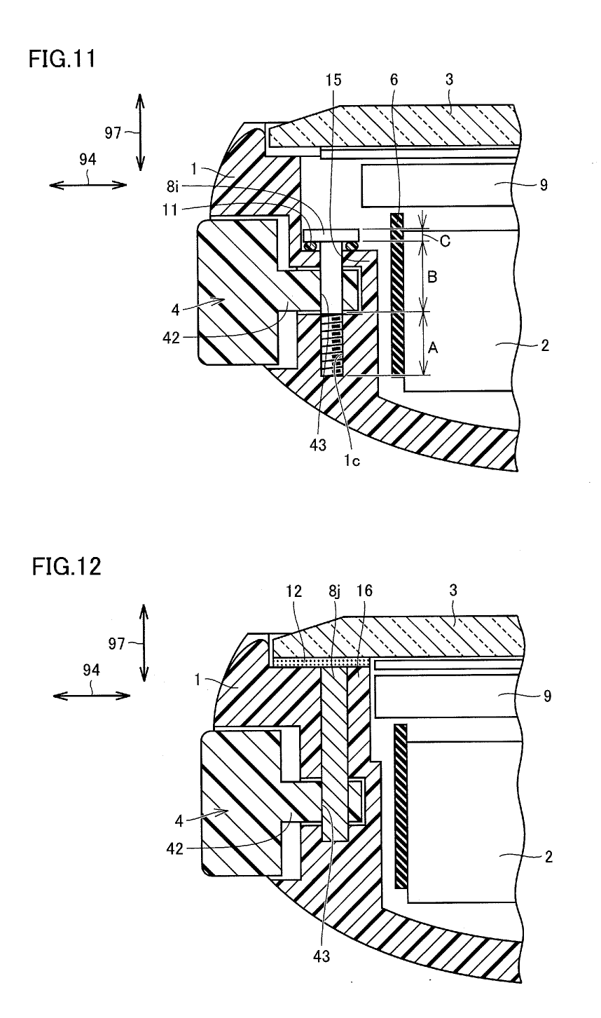

An electronic device in a second embodiment based on the present disclosure will be described with reference to FIGS. 10 and 11. FIG. 10 shows appearance of an electronic device 102 in the second embodiment. The appearance of electronic device 102 may be similar to the appearance of electronic device 101 described and shown in the first embodiment. Similarly to electronic device 101, cover glass 3 may be disposed on the main surface of electronic device 102. Electronic device 102 includes housing 1. FIG. 11 is a cross-sectional view taken along the line XI-XI in FIG. 10.

As shown in FIG. 11, electronic device 102 includes a shaft member 8i. Housing 1 includes a portion 15 supporting shaft member 8i. Portion 15 has a flat upper surface. A screw is provided in at least part of shaft member 8i, and at least part of a portion of shaft member 8i in which the screw is provided is screwed into housing 1. More specifically, at least part of the portion of shaft member 8i in which the screw is provided is screwed into portion 15 of housing 1. Shaft member 8i may be a bolt or a component similar to a bolt. Shaft member 8i includes a portion A, a portion B, and a portion C. Portion C is a portion corresponding to the head of shaft member 8i. A screw is provided in portion A of shaft member 8i. No screws are provided in portions B and C of shaft member 8i. Portion A is screwed into housing 1. A waterproof gasket 11 is disposed between portion C of shaft member 8i and portion 15 of housing 1. Waterproof gasket 11 may be an annular member. Waterproof gasket 11 may be formed of elastic material. In the example shown in FIG. 11, waterproof gasket 11 is pressed against the flat upper surface of portion 15. The upper surface of portion 15 may have any other shape.

In the second embodiment, waterproof gasket 11 corresponds to the second waterproof member. As described and shown in the second embodiment, waterproof gasket 11 serving as the second waterproof member may be disposed to be in contact with shaft member 8i and housing 1.

In the second embodiment, a screw is provided in at least part of shaft member 8i, and at least part of the portion of shaft member 8i in which the screw is provided is screwed into housing 1, thus firmly fixing shaft member 8i to housing 1. The position of shaft member 8i is stabilized after shaft member 8i has been screwed into housing 1, facilitating assembly work.

In the second embodiment, the second waterproof member may be, for example, annular waterproof gasket 11 (see FIG. 11), not sealing member 10 (see FIG. 8). This allows preparation of the second waterproof member as a single component, facilitating assembly work.

### Third Embodiment

An electronic device in a third embodiment based on the present disclosure will be described with reference to FIG. 12. The appearance of this electronic device may be similar to that of electronic device 101, 102 described above. Although FIG. 11 in the second embodiment shows a cross section, FIG. 12 shows a cross section of the electronic device in the third embodiment which is taken along a similar location.

As shown in FIG. 12, the electronic device in the third embodiment includes a shaft member 8j. Housing 1 includes a portion 16 supporting shaft member 8j. Portion 16 has a flat upper surface. The upper end of shaft member 8j almost reaches the lower surface of cover glass 3. The upper end surface of shaft member 8j may be flush with the upper surface of portion 16. Waterproof sheet 12 is disposed between cover glass 3 and the upper surface of portion 16 of housing 1. Waterproof sheet 12 is in contact not only with the upper surface of portion 16 but also with the upper end surface of shaft member 8j. As shown in FIG. 12 in the third embodiment, the second waterproof member may be disposed to be in contact with shaft member 8j and housing 1. In the third embodiment, waterproof sheet 12 corresponds to the second waterproof member.

Waterproof sheet 12 may be a double-sided pressure sensitive adhesive sheet having waterproof performance. Waterproof sheet 12 serves to fasten housing 1 and cover glass 3 thereto. Waterproof sheet 12 may be a double-sided pressure sensitive adhesive sheet having waterproof performance which has been conventionally used to bond cover glass 3 and housing 1 together.

If the electronic device is exposed to water, whether water enters the region inside housing 1 through the gap around shaft member 8j is a problem. In the third embodiment, however, shaft member 8j almost reaches the lower surface of cover glass 3, and waterproof sheet 12 serving as the second waterproof member is disposed in this portion, thus reducing a probability that water may enter the region inside of housing 1 through the gap around shaft member 8j. In the third embodiment, the waterproof sheet originally disposed to bond cover glass 3 and housing 1 together can be used without the need for preparing a new sheet as waterproof sheet 12, contributing to a reduction in the number of components.

### Fourth Embodiment

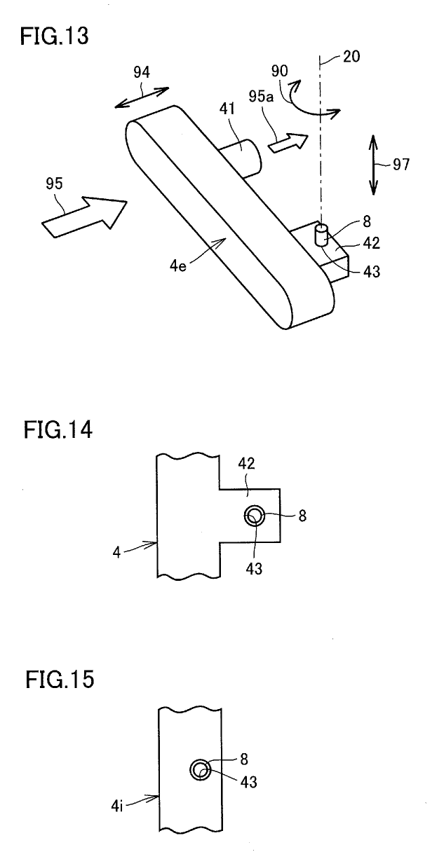

An electronic device in a fourth embodiment based on the present disclosure will be described with reference to FIG. 13. The electronic device in the fourth embodiment may be basically similar in configuration to electronic device 101 described in the first embodiment but differs from electronic device 101 in the following points.

The electronic device in the fourth embodiment includes a key member 4e as shown in FIG. 13 in place of key member 4. Key member 4e includes one protrusion 42 and one pusher 41. Since it suffices that one or more pushers 41 are provided, one pusher 41 may be provided as described and shown in the fourth embodiment.

Through-hole 43 is provided in protrusion 42. Shaft member 8 penetrates through-hole 43. Key member 4e has through-hole 43 as “one or more through-holes or one or more cutaway parts.”

The electronic device in the fourth embodiment includes one switch (not shown) as a switch to be pressed with key member 4e. Key member 4e holds shaft member 8 at a position close to one end and includes pusher 41 at a position close to the other end.

The electronic device may include key member 4e as described and shown in the fourth embodiment. Since key member 4e can pivot about one shaft member 8 as indicated by arrow 90, pusher 41 can be displaced back and forth. The user presses key member 4e as indicated by arrow 95, thus allowing pusher 41 to press the switch as indicated by arrow 95a. FIG. 13 shows forward and backward directions 94 of pusher 41.

### Fifth Embodiment

An electronic device in a fifth embodiment based on the present disclosure will be described with reference to FIGS. 14 to 18. The electronic device in the fifth embodiment may be basically similar in configuration to electronic device 101 described in the first embodiment but differs from electronic device 101 in the following points. In electronic device 101 in the first embodiment, as shown in FIG. 14, protrusion 42 is provided in any location of key member 4, and shaft member 8 is inserted into through-hole 43 provided in protrusion 42. This is merely an example, and various modifications are conceivable as an adoptable structure as described and shown in the fifth embodiment.

For example, as shown in FIG. 15, through-hole 43 may be provided in the body of key member 4 without providing a protrusion in key member 4. Then, shaft member 8 may be inserted into through-hole 43 provided in any location of the body of key member 4. Such a structure can also limit part of a displacement of key member 4 relative to housing 1.

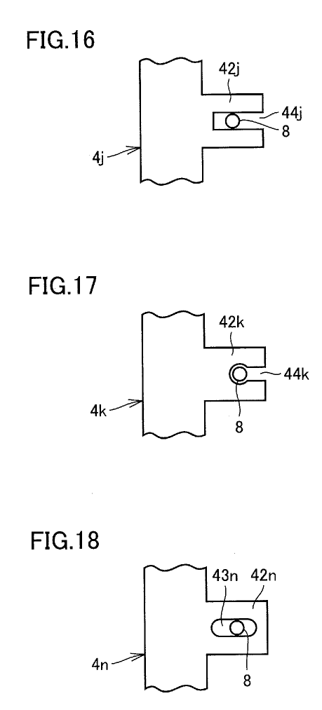

For example, as shown in FIG. 16, the electronic device may include a key member 4j in place of key member 4. Key member 4j is provided with a protrusion 42j. Protrusion 42j has a cutaway part 44j as “one or more through-holes or one or more cutaway parts.” Shaft member 8 is disposed in cutaway part 44j. Such a structure can also limit part of a displacement of key member 4j relative to housing 1.

For example, as shown in FIG. 17, the electronic device may include a key member 4k in place of key member 4. Key member 4k is provided with a protrusion 42k. Protrusion 42k has a cutaway part 44k as “one or more through-holes or one or more cutaway parts.” Cutaway part 44k is a straight cutaway part narrower than the diameter of shaft member 8 on the side close to the outlet and, on a side remote from the outlet, includes a circular cutaway portion having such a diameter as to accommodate shaft member 8 therein. Shaft member 8 is fitted into this circular cutaway portion. Such a structure can also limit part of a displacement of key member 4j relative to housing 1.

For example, as shown in FIG. 18, the electronic device may include a key member 4n in place of key member 4. Key member 4n is provided with a protrusion 42n. Protrusion 42n has a through-hole 43n as “one or more through-holes or one or more cutaway parts.” Through-hole 43n is a long hole. Shaft member 8 is inserted into through-hole 43n. The width of through-hole 43n may be greater than or equal to the diameter of shaft member 8. The length of through-hole 43n may be greater than the diameter of shaft member 8. Shaft member 8 can be displaced relatively in the longitudinal direction of through-hole 43n inside through-hole 43n.

Although several modifications related to the key member and the shaft member have been described above, the electronic device may adopt a combination of such structures.

### Sixth Embodiment

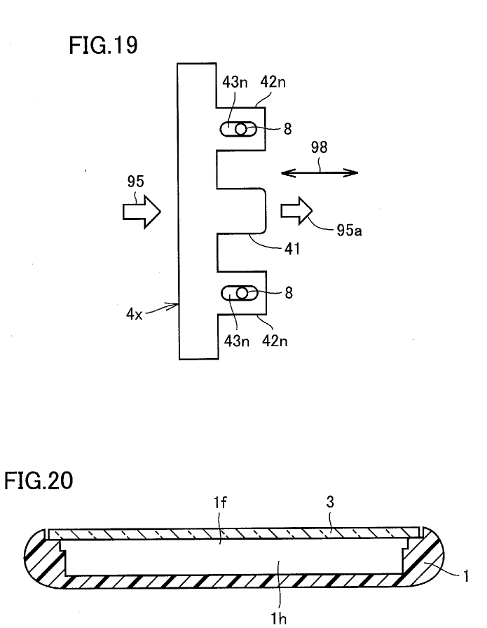

An electronic device in a sixth embodiment based on the present disclosure will be described with reference to FIG. 19. The electronic device in the sixth embodiment may be basically similar in configuration to electronic device 101 described in the first embodiment but differs from electronic device 101 in the following points.

The electronic device in the sixth embodiment includes a key member 4x in place of key member 4. Key member 4x includes two protrusions 42n and one pusher 41. One pusher 41 is disposed between the two protrusions 42n. Each protrusion 42n has a through-hole 43n. Key member 4x has two through-holes 43n. Shaft member 8 is inserted into each through-hole 43n.

In the electronic device in the sixth embodiment, the user can press key member 4x as indicated by arrow 95 to move shaft members 8 relatively in two through-holes 43n, substantially subjecting key member 4x to translation. When the user presses key member 4x as indicated by arrow 95, pusher 41 can advance as indicated by arrow 95a to press the switch. FIG. 19 shows forward and backward directions 98.

Housing 1 may be formed of a single component as shown in FIG. 20, which applies to some embodiments described above. In the example shown in FIG. 20, housing 1 has, for example, a container shape and has an opening if on the side corresponding to one main surface. Cover glass 3 covers opening 1f, so that an interior space 1h of housing 1 is closed almost entirely. Various components may be disposed in interior space 1h. FIG. 20 does not show the components disposed in interior space 1h for the sake of convenience of description. Although FIG. 20 does not show a key member, a switch, and the like, opening 1a for disposing a key member may be provided in any location of housing 1. An operation button may be configured with a key member in any location on a side surface of housing 1.

When housing 1 is formed of a single component to have a low profile, a space for providing an operation button is particularly limited to a narrow space. In such a case, the embodiments as described above can be applied to dispose the operation key, compactly achieving an operation button. As shown in FIG. 1, housing 1 may be a thin plate-shaped member and has an operation button provided on a side surface of housing 1.

Housing 1 may be configured by a combination of a plurality of components, as well as being formed of a single component.

Some features in embodiments above may be adopted as being combined as appropriate.

Although description has been given so far by using the term “electronic device,” the electronic device is a broad concept covering, for example, a portable telephone, a portable information terminal, a tablet terminal, a personal computer, a game console, a television receiver, a portable music player, a CD player, a DVD player, an electronic calculator, an electronic organizer, an electronic dictionary, an electronic book reader, a digital camera, a video camera, a radio receiver, a navigation system, and a measurement instrument. The concept of the portable telephone or the portable information terminal includes a smartphone.

Although embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

### REFERENCE SIGNS LIST

1 housing, 1a opening, 1b cutaway part (for receiving shaft member), 1c receiving hole, 1f opening, 2 inner chassis, 3 cover glass, 4, 4i, 4j, 4k, 4n, 4x key member, 5 first waterproof member, 5r reinforced member, 6 flexible substrate, 7 switch, 8, 8i, 8j shaft member, 9 display, 10 sealing member, 11 waterproof gasket, 12 waterproof sheet, 15, 16 portion (in which housing supports shaft member), 20 axis of rotation, 41 pusher, 42, 42j, 42k, 42n protrusion, 43, 43n through-hole, 44j, 44k cutaway part, 90 arrow (indicating pivot of key member), 91, 92, 93 arrow, 94, 98 forward and backward directions (of pusher), 95, 96 arrow (indicating user's pressing force), 95a, 96a arrow (indicating pusher's pushing movement), 97 longitudinal direction (of shaft member), 101 electronic device.

1. An electronic device comprising:
a housing having an opening;
a key member including one or more pushers projecting inwardly of the housing, having one or more through-holes or one or more cutaway parts, and disposed to allow the one or more pushers to pass through the opening;
one or more switches each disposed to face a corresponding one of the one or more pushers inside the housing;
a first waterproof member disposed between each of the one or more pushers and each of the one or more switches; and
one or more shaft members fixed to the housing,
each of the one or more shaft members entering the one or more through-holes or the one or more cutaway parts so as to limit part of a displacement of the key member relative to the housing.

2. The electronic device according to claim 1, wherein a longitudinal direction of each of the one or more shaft members is perpendicular to forward and backward directions of the one or more pushers.

3. The electronic device according to claim 1, wherein
the one or more pushers comprise two pushers,
the one or more through-holes or the one or more cutaway parts comprise one through-hole or one cutaway part, and
the one through-hole or the one cutaway part is located between the two pushers.

4. The electronic device according to claim 1, wherein
the first waterproof member has a bag shape, and
each of the one or more pushers is coated with the first waterproof member.

5. The electronic device according to claim 1, further comprising a second waterproof member disposed to be in contact with the one or more shaft members and the housing.

6. The electronic device according to claim 1, wherein
at least part of the one or more shaft members is provided with a screw, and
at least part of a portion of the one or more shaft members in which the screw is provided is screwed into the housing.

7. The electronic device according to claim 1, wherein the housing is formed of a single component.

8. The electronic device according to claim 1, wherein the one or more shaft members is fixed to the housing while passing through the key member.
